(19) United States
(12) Patent Application Publication
(10) Pub. No.: US 2003/0185185 A1
(43) Pub. Date: Oct. 2, 2003

(54) WIRELESS LOCAL AREA NETWORK ACCESS CONTROLLER AND RELATED METHOD

(76) Inventors: Chih-Hao Chang, Taipei City (TW); Ming-Hsun Hsu, Taipei City (TW); Chih-Hsien Weng, Miao- Li Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,028

(22) Filed: Mar. 11, 2003

(30) Foreign Application Priority Data
Mar. 26, 2002 (TW) 091105954

(51) Int. Cl. H04Q 7/24

(52) U.S. Cl. 370/338

(57) ABSTRACT

A wireless local area network access controller for receiving a first frame signal complying with a first format includes a conversion circuit for retrieving a second frame signal complying with a second format according to the first frame signal complying with the first format and for retrieving an access control signal. The wireless local area network access controller also includes an access circuit for processing the second frame signal complying with the second format. The wireless local area network access controller is capable of performing a hardware control according to the access control signal.

### BACKGROUND OF INVENTION

1. Field of the Invention

The present invention relates to a wireless local area network (WLAN) medium access control chip (MAC) and related method, and more specifically, to a simplified wireless LAN chip that is capable of utilizing a MAC controller embedded in a south bridge chip.

2. Description of the Prior Art

In the modern society where network structure is rapidly developing, vast amounts of text, data, and video information flows at fast speed through computer networks. This facilitates people to share the skills and experience with others to further advance the overall knowledge level of society. How best to provide a convenient network connection with good quality to ensure that everyone can share network resources has become one of the major focuses of the IT industry.

With the widespread use of personal computers (PCs), many network connection devices are designed specifically for with PCs, which allows for point-to-point wired connections between PCs having network interface devices and computer networks. Please refer to FIG. 1, which is a functional block diagram of a computer 10. Generally, the computer 10 comprises, a central processing unit (CPU) 12 for controlling the computer 10, a north bridge chip 14, a memory 18 (such as a random access memory)for temporarily storing program and data, a VGA card 16 for displaying images, a monitor 11, a south bridge chip 32, a hard disk 34, and a peripheral device 36. The north bridge chip 14 is electrically connected to the CPU 12, the memory 18, and the VGA card 16, to coordinate high speed data transfer therebetween. The south bridge chip 32 includes a bridge circuit 20 which connects to hard disk 34, and via a peripheral component interface (PCI) bus 40 links to the peripheral device 36 and north bridge chip 14 to manage data transfer among hard disk 34, various peripheral devices (such as a sound card), and the CPU 12.

As mentioned above, many PCs already have built-in mechanism to support the wired LAN networking. A first access circuit 22A within the south bridge chip 32 of the computer 10 is used to connect the computer 10 to a wired LAN. As for the first built-in access circuit 22A (such as a 802.3 media access control (MAC) circuit)within south bridge chip 32, a user would just have to install a first LAN card 46A, which through a wire medium circuit 48 is linked to a first LAN 26A. Similarly, the first access circuit 22A is coupled to the bridge circuit 20 via the PCI bus 40. The first LAN card 46A includes a first physical layer circuit 24A, which is coupled to the first access circuit 22A via a communications interface bus 42. The communication interface bus 42 connects to first LAN card 46A via either an advanced communication riser (ACR) slot or a network communication riser(NCR) slot.

Since a universal network structure is required for network data transmission by various models of computers that access to the same network. Open system interconnection (OSI), a network structure standard, has thus been established and recognized internationally to serve this purpose. Under this structure there are seven layers of regulation for network data transmission. For example, the first physical layer circuit 24A within the first LAN card 46A is used to realize the physical layer function of this structure, whereas the first access circuit 22A within the south bridge chip 32 is used to realize a data link layer function of this structure. Working in conjunction with the first access circuit 22A and the first physical layer circuit 24A, the memory 18 in the computer 10 loads a corresponding driver program 50 to complete the function of data link layer and physical layer.

When computer 10 starts to transmit data to the first LAN 26A, it transmits the data to the first access circuit 22A via the PCI bus 40. The first access circuit 22A cooperates with the driver program 50 to encapsulate the data into a first frame signal 30A, which is transmitted to the first physical layer circuit 24A within the first LAN card 46A in a bit stream. The first physical layer circuit 24 then encodes and modulates the first frame signal 30A into the first transmission signal 32A to be transmitted on a transmission line 48, to the first LAN 26A, for networking.

A header and a frame check sequence (FCS) are appended to the data. The header includes preamble data and start frame delimiter (SFD) data, source MAC address and destination MAC address, along with other relevant data. The FCS is used to verify the bit sequence of the first frame signal 30A. To facilitate data transmission among different computers, the header and the FCS are subject to a uniform protocol during encapsulating the first frame signal 30A. For instance, the IEEE 802.3 specification currently in use for Ethernet universally stipulates the definition of each data in the header, along with the syntax for its corresponding bit length and address data, etc. The first physical layer circuit 24A within the first LAN card 46A transforms the first frame signal 30A (in a bit stream)into a first transmission signal 32A through encoding and modulating, and drives the first transmission signal 32A to the transmission line 48 in different voltage levels. Since the transmission line 48 includes different shapes and sizes, such as twisted-pair, coaxial cable, or fiber optics, electronic signals have different characteristics due to different medium characteristics and different transmission speeds.

Assume another computer on the first LAN 26A transmits data to the computer 10 in the form of an electronic signal. Upon receiving the electronic signal, the first physical layer circuit 24A demodulates it into the first frame signal 30A, and transmits it to the first access circuit 22A. After receiving the first frame signal 30A, the first access circuit 22A, cooperating with the driver program 50, performs decoding the frame structure and retrieving the data within, and transmits the data to PCI bus 40, which renders it accessible to the computer 10.

In addition to actually transmitting and receiving electronic signals, the first physical layer circuit 24A also senses a transmission status of the electronic signal on the transmission line 48. During exchanging data between computers connected to the LAN, there is the possibility of electronic signal collision. In other words, when the computer 10 sends out an electronic signal via the LAN transmission line 48, and on the transmission line 48 there happens to be another electronic signal is transmitted to the computer 10, a collision occurs and fails the transmission of an electronic signal. To prevent this, the first physical layer circuit 24A can detect the electrical state on the transmission line 48, to determine whether or not there is electronic signal in transmission. For instance, under the IEEE 802.3 specification, carrier sense multiple access with collision detection (CSMA/CD) is used for collision detection. When the first physical layer circuit 24A detects the carrier (meaning an electronic signal is in transmission), it notifies the first access circuit 22A which refrains from issuing a request to the first physical layer circuit 24A for transmitting electronic signals to the transmission line 48, thus reducing the possibility of collision. When collision occurs, the first physical layer circuit 24A notifies the first access circuit 22A, which then decides when to re-transmit an electronic signal from the first physical layer circuit 24A, along with the lead time required prior to transmission.

With developing the wireless communication technology, wireless LANs have become more important for connecting to the Internet. Wireless LAN facilitates portable or mobile networking. For instance, if wireless LAN is available to a notebook computer, a user could access to the Internet from nearly anywhere, even when the user is in motion (as in a moving car).The user could access the Internet via wireless hook-up, thus greatly boosting his productivity.

Please refer to FIG. 1. The second LAN card 46B in the computer 10 connects to the PCI bus 40. The LAN card 46B comprises a bus interface circuit 52, a second access circuit 22B, and a second physical layer circuit 24B. The second physical layer circuit 24B comprises a baseband circuit 54A and a radio frequency (RF) circuit 54B. The second LAN card 46B connects to the computer 10 via the PCI bus 40. The bus interface circuit 52 in the second LAN card 46B is used to manage the data exchange between the second LAN card 46B and the computer 10 via the PCI bus 40 working in conjunction with the associated driver, the second access circuit 22B, and the second physical layer circuit 24B to perform the functions of data link layer and physical layer. When the computer 10 attempts to transmit data wirelessly to the second LAN 26B, it first transmits the data to the bus interface circuit 52 via the PCI bus 40, which transmits the data to the second access circuit 22B, which controls the second physical layer circuit 24B and transmits the second frame signal 30B (with data encapsulated) to the second physical layer circuit 24B. In the second physical layer circuit 24B, the baseband circuit 54A modulates the second frame signal 30B into a baseband signal. This is followed by further modulation by the radio frequency circuit 54B into a second LAN transmission signal 32B (a radio frequency electronic signal), to be transmitted wirelessly, thus linking the computer 10 wirelessly to the second LAN 26B. Assume that there is data (in electronic signal form) in the second LAN 26B being transmitted to the computer 10 wirelessly, the data is first received by the radio frequency circuit 24B within the LAN card 46B, and then demodulated into a baseband signal and decoded by the baseband circuit 24B into a second frame signal 30B for transmission to the second access circuit 22B. Therefore, the second access circuit 22B can retrieve the data within the second frame signal 30B, which then becomes accessible to the computer 10.

Similar to the wired LAN, the driver associated with the second access circuit 22B encapsulates data into the second frame signal 30B, and further appends a header and frame check sequence to the data. However, because of the inherent differences between wireless and wired connections, there are different protocols and specifications to follow when encapsulating the second frame signal 30B. For instance, IEEE 802.11 Ethernet is adopted to regulate the framing format in wireless LANs. Once the electronic signal is transmitted out wirelessly (via electromagnetic waves or infrared radiation), any computer with the corresponding radio frequency receiving circuit is capable of freely receiving the wireless electronic signal. This invariably poses security and privacy threats to data in a wireless LAN. Accordingly, the IEEE 802.11 specification addresses managing frame signals to authenticate access rights in a wireless LAN to safeguard security and privacy of data. In addition, because of the portability and mobility for wireless LAN clients, there are four address locations in the header(as opposed to only two in a wired LAN), which enables a computer to link to the wireless LAN regardless of its location when transmitting electronic signals. Also, to reduce power consumption in the second LAN card 46B, the second frame signal header includes power management data. All of the aforementioned features render the frame signal in the wireless LAN incompatible with that in a wired LAN. Moreover, when the second access circuit 22B controls the second physical layer circuit 24B, the required functions vary depending on the unique features of the wireless LAN connection. For instance, the second access circuit 22B is capable of controlling the second physical layer circuit 24B to link to the second LAN 26B by using different bandwidth.

One drawback for the prior art computer 10 as described lies in the fact that the second LAN card 46B links to the computer 10 via the PCI bus 40. To prevent peripheral devices from interfering with one another during data transmission on the same PCI bus 40, every interface circuit that connects a peripheral device to the PCI bus 40 is specially designed to cooperate with the bridge circuit 20 for coordinating data transmission on the PCI bus 40. The PCI bus 40 comprises a plurality of a multitude of traces, and every trace can transmit specific data or command. The bus interface circuit 52 within the second LAN card 46B is specially designed to interface with the PCI bus 40. For instance, the bus interface circuit 52 is able to decode addresses to identify whether or not the signal on PCI bus 40 is meant for the second LAN card 46B. In addition to the traces that transmit signals, the bus interface circuit 52 also informs the data transmission status of the second LAN card 46B. Because the bus interface circuit 52 is responsible for implementing lots of complex functions, higher cost results from its circuit design.

Another conventional LAN card includes a local CPU, a random access memory, a high capacity flash memory, a media access control (MAC) chip, and a physical layer chip. The high capacity flash memory stores firmware for the dedicated CPU in conjunction with the random access memory to transceive the signal in a wireless LAN by the MAC chip and the physical layer chip.

### SUMMARY OF INVENTION

The primary objective of the claimed invention is utilizing an access circuit within the bridge chip to integrate the expansion effort of a wired or a wireless LAN to simplify the configuration needed in accessing network resources via a peripheral bus as well as overcoming the weaknesses in the prior art technology.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a computer according to the prior art.

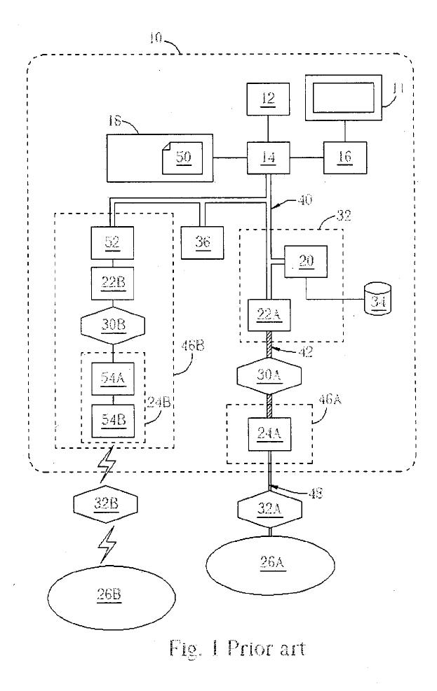

FIG. 2 is a block diagram of a computer according to the present invention.

FIG. 3 illustrates a relationship between the second frame signal and the first frame signal of the computer in FIG. 2.

### DETAILED DESCRIPTION

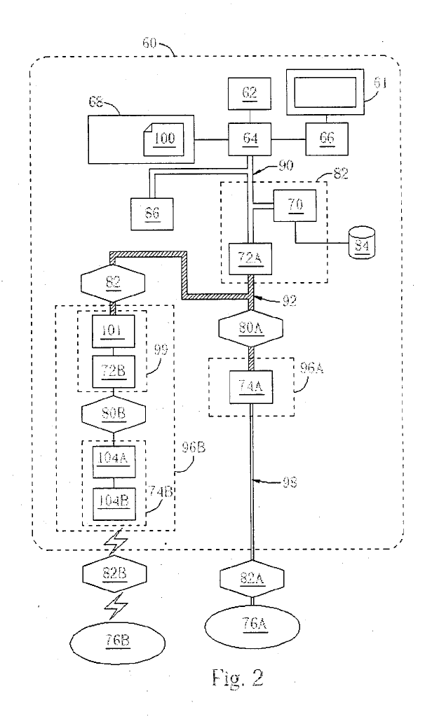

Please refer to FIG. 2, which illustrates a functional block diagram of a computer 60 according to the present invention. The computer 60 includes a CPU 62, a display 61, a memory 68 for temporary data/program storage (for instance a random access memory), a VGA card 66 for processing graphic data, a north bridge chip 64, a south bridge chip 82, and a hard disk 84. The north bridge chip 64 is electrically connected to the memory 68, the CPU 62, the VGA card 66, and the peripheral bus 90, to transfer data among them. The south bridge chip 82 includes a bridge circuit 70 for managing the hard disk 84 and a peripheral device 86 that links to peripheral bus 92, which transfers data to the CPU 62 via the north bridge chip 64. The peripheral device 86 could be a sound card or a small computer system interface (SCSI) card.

As mentioned above, conventional computers can build in an 802.3 MAC access circuit within a south bridge chip to support a wired LAN. The computer 60 of the present invention is capable of utilizing the conventional south bridge chip to expand access capability to wireless LANs. As illustrated in FIG. 2, the south bridge chip 82 has a built-in first access circuit 72A. Through the first access circuit 72A, computer 60 uses a first LAN card 96A that connects to the communication interface bus 92 to access resources in a LAN 76A via a network transmission line 98. The first LAN card 96A also connects to the communications interface bus 92 via either an advanced communication riser (ACR) or a network communication riser (NCR).

When computer 60 tries to link to the first LAN 76A via a wired connection, it uses the first access circuit 72A in conjunction with a driver program 100 in the temporary memory 68 to complete the function of a data link layer in OSI standard. The first physical layer circuit 74A in first LAN card 96A performs the function of a physical layer. When the computer 60 starts to transmit data to the first LAN 76A, the data gets encapsulated into a first frame signal 80A (for instance, in accordance with the IEEE 802.3 specification), and transmitted to the first physical layer circuit 74A in the first LAN card 96A via the communication bus 92. In the first physical layer circuit 74A, the first frame signal 80A is encoded and modulated into a first network transmission signal 82A suitable for transmission on the network transmission line 98. Under the control of the first access circuit 72A, the first network transmission signal 82A (in the form of a real electronic signal) is transmitted to the first LAN 76A via the network transmission line 98. Similarly, assume that there is an electronic signal in the first LAN 76A being transmitted to the computer 60 via the network transmission line 98, the signal is decoded and demodulated into a first frame signal 80A by the first physical layer circuit 74A, so the computer 60 is capable of accessing the first LAN 76A via the network transmission line 98.

To expand the wireless LAN access capability of the computer 60, a second LAN card 96B replaces the first LAN card 96A to wirelessly access the second LAN 76B. The second LAN card 96B is coupled to the first access circuit 72A of the south bridge chip 82 via the communication bus 92. Since the first access circuit 72A is embedded into the south bridge chip 82, it can access the peripheral bus 90. If the medium accessibility of the first access circuit 72A, such as 802.3 MAC, can be utilized by a wireless device, the complexity of the WLAN card 96B can be reduced. Furthermore, the present invention does not require a complicated and high cost bus interface circuit 52 as in the second LAN card 46 of the prior art.

The second LAN card 96B of the present invention includes an access controller 99 and a second physical layer circuit 74B. The access controller 99 comprises a conversion circuit 101 and a second access circuit 72B. The second physical layer circuit 74B comprises a baseband circuit 104A and a radio frequency circuit 104B. The second access circuit 72B cooperates with the driver program 100 to realize the data link layer in OSI. The second physical layer circuit 74B performs the functions in the physical layer. The second access circuit 72B transmits a second frame signal 80B (in accordance with the IEEE 802.11 specification, for instance) to the second physical layer circuit 74B. The baseband circuit 104A encodes and modulates the signal into a baseband signal that is then radiated by the radio frequency circuit 104B in a second transmission signal, a radio frequency. Thus, the computer 60 can access the wireless LAN 76B. Assume that the second LAN card 96B receives a radio frequency signal from the second LAN 76B, the radio frequency circuit 104B converts the signal into a baseband electronic signal, and decodes and demodulates it into the second frame signal to be transmitted back to the second access circuit 72B.

The second LAN card 96B is coupled to the south bridge chip 82 through the communication bus 92. To cooperate with the first access circuit 72A, the second LAN card 96B includes the conversion circuit 101. Since the first access circuit 72A is used to generate and transmit the first frame signal, the signal transmitted to the second LAN card 96B through the first access circuit 72A conforms to the format of the first frame signal (such as IEEE 802.3 for wired LANs). The second access circuit 72B within the second LAN card is capable of generating the second frame signal according to the first frame signal (such as IEEE 802.11) to perform the function of data link layer in the wireless LAN. As previously discussed, the first frame format transceived in the wired LAN is incompatible with the second frame format for the wireless LAN, due to the different natures and different applications of the two types of networks. Hence, the second LAN card 96B of the present invention utilizes the conversion circuit 101 in conjunction with the driver program 100, to coordinate data transmission between the first access circuit 72A and the second access circuit 72B.

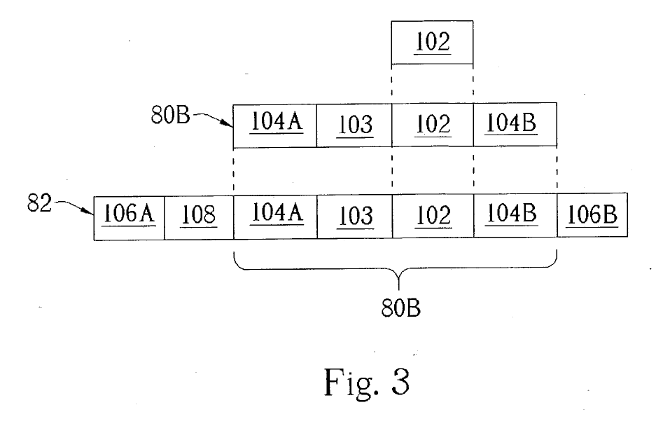

Please refer to FIG. 3 and FIG. 2. FIG. 3 illustrates the change of frame format between the first access circuit 72A and the second access circuit 72B in the computer 60. When the computer 60 attempts to wirelessly transmit a data frame 102 complying with the first format to the second LAN 76B, the driver program 100 appends header 104A complying with the second frame format and an associated logical link control (LLC) signal 103, along with generating corresponding second format frame check sequence 104B at the host side. According to the present invention, when generating the second frame signal 80B complying with the second format, the driver program 100 appends an access control signal 108 in front of the second frame signal 80B, and further appends a first format header 106A and frame check sequence 106B to form a first frame signal 82 complying with the first format. In this way the second frame signal 80B is packaged to a first frame signal 82 complying with the first format, so as to perform the function of the data link layer in a wired LAN. Thus, the first frame signal 82 is transmitted to the conversion circuit 101 in the second LAN card 96B by the first access circuit 72A via the communication bus 92 (for details please refer to FIG. 2). Upon receiving the first frame signal 82, the conversion circuit 101 retrieves the access control signal 108 and the second frame signal 80B. The second access circuit controls the second physical layer circuit 74B according to the access control signal 108 in converting the second frame signal 80B into the second network transmission signal 82B. The data in the access control signal 108 is used to control the second access circuit 72B and the second physical layer circuit 74B. Preferrably, the access control signal 108 specifies a predetermining bandwidth which allows the second access circuit 72B to control what bandwidth the second physical layer circuit 74B could use to transmit the second network transmission signal 82B to the second LAN 76B.

In contrast, when the second physical layer circuit 96B receives a network transmission signal from the second LAN 76B, it decodes and demodulates the signal into a second frame signal. The conversion circuit 101 appends the first format header and the first format frame check sequence at the front and rear of the second frame signal respectively, allowing the second frame signal to be wrapped in a first frame signal. Then, the wrapped frame signal is transmitted back to the first access circuit 72A via the communication bus 92. Through the driver program 100, the second frame signal in the first frame signal can be retrieved by the computer 60.

Furthermore, the south bridge chip 82 embedded with the 802.3 media access control(MAC) circuit 72A is coupled to a wireless MAC chip 99 of the present invention cooperating with the driver program 100 to perform the function of a link layer in the wireless LAN (for instance, as in 802.11 wireless LAN). In this embodiment, the driver program 100 should be modified from that used in 802.3, or the 802.3 network driver interface specification (NDIS). The new driver according to this invention includes the 802.3 NDIS driver program and 802.11 driver program. When the computer 60 tries to wirelessly transmit data, the NDIS driver program starts packaging the data into the data frame 102 complying with the 802.3 specification, which comprises an 802.3 MAC header, an 802.3 payload, and an 802.3 cyclic redundancy check (CRC) in sequence. The computer 60 appends an 802.11 header 104A, and an LLC control signal 103 to the 802.3 data frame 102, and generates a corresponding 802.11 check sequence 104B to form a frame signal 80B complying with the 802.11 specification utilizing the 802.11 driver program. Then, the driver program 100 appends an appropriate access control signal 108 at the front of the 802.11 frame signal 80B, and appends an 802.3 header 106A and an 802.3 frame check sequence 106B to form a communication signal 82 complying with the 802.3 specification. The 802.3 MAC circuit 72A of the south bridge chip 82 transmits the signal 82 complying with the 802.3 specification to the wireless LAN access controller 99 via an MII or PCI bus. The conversion circuit 101 extracts the access control signal 108 and the 802.11 frame signal 80B. The 802.11 access circuit 72B processes the frame signal 80B. The wireless LAN access controller 99 controls the wireless LAN access controller 99 or the 802.11 physical layer circuit 74B in response to the access control signal 108. Finally, the 802.11 physical layer circuit 74B radiates the 802.11 frame signal 80B via air, comprising the 802.11 header 104A, the LLC control signal 103, the 802.x series payload, and the corresponding 802.11 frame check sequence 104B. Since the 802.2 LLC control signal 103 stipulates the medium access under the 802.x series specifications, thus promising that the packet generated by the present invention can be retrieved by any remote 802.11 devices.

In the south bridge chip 82 according to the first embodiment, since the 802.3 MAC circuit 72A transmits the communication signal 82 complying with the 802.3 specification to the wireless LAN access controller 99 via the MII inside a single computer, we can further improve the system performance. For instance, in the second embodiment according to this invention, the driver program comprises an 802.3 NDIS driver program and an 802.11 driver program. The 802.3 NDIS driver program is capable of packaging data into a data frame 102 complying with the 802.3 specification, which comprises a 802.3 MAC header, an 802.3 payload, and an 802.3 check sequence. The 802.11 driver program appends only an 802.11 header 104A and an LLC control signal 103 to the 802.3 data frame 102 without generating the 802.11 check sequence 104B. The driver program 100 then appends an access control signal 108 properly. Then, the 802.3 MAC circuit 72A of the south bridge chip 82 transmits the same to the wireless LAN access controller 99 directly via the MII. The conversion circuit 101 of the wireless LAN access controller 99 retrieves the access control signal 108 from within, and at then the conversion circuit 101 generates a corresponding 802.11 frame check sequence 104B based on the remaining 802.11 header 104A, the LLC control signal 103, and the data frame 102 complying with 802.3 specification by hardware. All following operations by the 802.11 access circuit 72B are thus omitted here given their similarity to the former embodiment. Hence, the final 802.11 frame signal 80B still comprises the 802.11 header 104A, the LLC control signal 103, the 802.x payload, and the corresponding 802.11 frame check sequence 104B to be retrieved by any remote 802.11 device. From the second embodiment, in the south bridge chip 82, the 802.11 check sequence 104B, the 802.3 header 106A, and the 802.3 frame check sequence 106B are optional. Thus, the data throughput is enhanced. During implementation, mode setting in the driver program 100 determines whether or not to add relevant headers or check sequences.

From the aspect of data transmission, as illustrated in the first embodiment, the 802.11 physical layer circuit 74B receives a radio frequency signal from the wireless LAN through air medium, and decodes it into an 802.11 frame signal 80B, which is then transmitted to the wireless LAN access controller 99 of the present invention. Typically, such 802.11 frame signal 80B comprises an 802.11 header 104A, an LLC control signal 103, an 802.x payload, and a corresponding 802.11 check sequence 104B. The 802.11 access circuit 72B of the wireless LAN access controller 99 processes the 802.11 frame signal 80B and selectively adds a control signal 104A. The conversion circuit 101 packages it into a communication signal 82 complying with the 802.3 specification for transmission to the south bridge chip 82 via the MII. So, the south bridge chip 82 can receive the communication signal 82 complying with the 802.3 specification by utilizing the embedded 802.3 MAC circuit 72A. The driver program 100 of this invention retrieves the 802.x payload 102 according to the 802.11 frame signal 80B, utilizing the LLC control signal 1 03 at the host side.

As for the second embodiment of the present invention, the efficiency and throughput of the computer 60 can be further improved. Between the wireless LAN access controller 99 and the south bridge chip 82 of the present invention, as disclosed above, there is no need to transmit the standard 802.3 frame signal. As illustrated by both embodiments, the resulting wireless transmission signals are all 802.11 radio frequency signals comprising an 802.11 header 104A, an LLC control signal 103, an 802.x payload 102, and an corresponding 802.11 check sequence 104B.

As to implementation, the access controller 99 emulates a physical layer circuit complying with the first format. In other words, as far as the first access circuit 72A is concerned, the access controller 99 is capable of emulating a first physical layer circuit 74A. For instance, an 802.11 MAC chip of the present invention coupled to the south bridge chip via the MII emulates an 802.3 physical layer circuit for cooperating with the south bridge chip, including, for example, register settings of an 802.3 physical layer circuit and the interface communication, etc. As mentioned earlier, the access controller 99 and the first physical layer circuit 74A can process data of the first format, and cooperate with the first access circuit 72A managing the first format data. More particularly, the conversion circuit 101 of the access controller 99 is capable of converting data between the first format and the second format to facilitate connection to the second LAN.

In summary, the present invention utilizes the first access circuit 72A of the south bridge chip 82 to enhance its access capability to the wired first LAN 76A and the wireless second LAN 76B, expanding the capacity of the first access circuit 72A originally meant to support only the wired LAN. The present invention discloses the second LAN card 96B comprising a conversion circuit 82 and a driver program 100 driving the conversion circuit. The second frame signal 80B appended with the control access signal 108 for the second access circuit 72B is encapsulated into a first format communication signal, to communication with the first access circuit 72A via the communication bus 92. So, two different types of frame signals can be managed by the same first access circuit 72A cooperating with the driver thereby enhancing the computer 60 to communication with the first LAN 76A and the second LAN 76B. In yet another embodiment, the communication bus 92 adopts a disable/able mode to coordinate and control data transmission between the first LAN card 96A, the second LAN card 96B and first access circuit 72A. In such an implementation, when the first access circuit 72A and the first LAN card 96A attempt to exchange data, the data transmission capacity of the second LAN card 96B in the communication bus 92 becomes disabled, to avoid interfering with the data exchange between the first access circuit 72A and the first LAN card 96A. When the first access circuit 72A and the second LAN card 96B attempt to exchange data, data transmission capacity of the first LAN card 96A in the communication bus 92 also becomes disabled. Under this mode of data exchange, the interface circuit that links both the second LAN card 96B and the first LAN card 96A to the communication bus 92 is simplified significantly. Notably the second LAN card 96B no longer requires complicated access capability of a peripheral bus as required by the second LAN card 36B in the prior art technology, nor is the installation of the bus interface circuit 52 required.

In addition to the aforementioned advantages, the present invention can access a wired network or a wireless LAN via the first access circuit 72A in the south bridge chip 82. Thus, the circuit design is simplified and gate counts in the second LAN card 36B. Furthermore, the present invention utilizes the host CPU 62 cooperating with the driver program 100 to generate the second format data for the second LAN 76B, and encapsulate the same into the first format data. Accordingly, the access controller 99 of the second LAN card requires no dedicated local CPU, random access memory, and high capacity flash memory. In other words, the host CPU 64 utilizes the existing resources of the computer 60 (for instance, the memory 68 and the hard disk 84) to share WLAN hardware loading, which greatly reduces the circuit structure of the access controller 99, and improves the maintenance of the second LAN card. Meanwhile, the CPU 64 is capable of processing, by cooperating with the driver program 100 for transceiving data, such as encryption, with greater flexibility and expandability. For instance, if the need arises to further adapt to the latest network transmission standard, one only needs to update the driver program rather than the change access controller 99. The communication bus 92 of the present invention is capable of transmitting data at high speed, meeting the speed requirement for data transmission. The first access circuit 72A within the south bridge chip 82 is capable of transceiving data at 100 Mbps or even 1 Gbps, which ensures the bandwidth upgrades in wireless network transmission. Moreover, there is no need to change the hardware design of the south bridge chip 82 for wireless transmission. For instance, the wireless LAN card of the present invention includes a low-cost electrically erasable programmable read only memory (EEPROM), a wireless LAN chip, wherein the EEPROM is used to initialize the hardware set-up for the wireless LAN card.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A wireless local area network access controller for receiving a first frame signal complying with a first format, the wireless local area network access controller comprising:
a conversion circuit for retrieving a second frame signal complying with a second format ac cording to the first frame signal complying with the first format and for retrieving an access control signal; and
an access circuit for processing the second frame signal complying with the second format;
wherein the wireless local area network access controller is capable of performing a hardware control according to the access control signal.

2. The wireless local area network access controller of claim 1 wherein the first frame signal complies with an IEEE 802.3 communication protocol.

3. The wireless local area network access controller of claim 1 wherein the second frame signal complies with an IEEE 802.11 communication protocol.

4. The wireless local area network access controller of claim 3 wherein the wireless local area network access controller is coupled to a south bridge chip, the wireless local area network access controller receiving the first frame signal from the south bridge chip.

5. The wireless local area network access controller of claim 4 wherein the wireless local area network access controller is coupled to a physical layer chip, and the wireless local area network access controller is capable of controlling the physical layer in response to the access control signal.

6. The wireless local area network access controller of claim 5 wherein the second frame signal comprises an IEEE 802.11 header, an LCC control signal, an IEEE 802.x payload, and an IEEE 802.11 check sequence.

7. The wireless local area network access controller of claim 5 where in the wireless local area network access controller receives the second frame signal from the physical layer, and the conversion circuit is capable of encapsulating the second frame signal into the first frame signal.

8. The wireless local area network access controller of claim 5 wherein the wireless local area network access controller is capable of transmitting the first frame signal to the south bridge chip via a communication interface.

9. The wireless local area network access controller of claim 8 wherein the communication interface is a media independent interface(MII).

10. The wireless local area network access controller of claim 8 wherein the communication interface is a PCI interface.

11. A wireless local area network access controller for receiving a first frame signal, the wireless local area network access controller comprising:
a conversion circuit for retrieving a second frame signal from the first frame signal, for retrieving an access control signal, and for generating a check sequence from the second frame signal, so that the second frame signal complies with a wireless local area network transmission format; and
an access circuit for managing the frame signal complying with the wireless local area network transmission format;
wherein the wireless local area network access controller is capable of executing a hardware control according to the access control signal.

12. The wireless local area network access controller of claim 11 wherein the second frame signal complies with an IEEE 802.11 communication protocol.

13. The wireless local area network access controller of claim 12 wherein the wireless local area network access controller is coupled to a south bridge chip, the wireless local area network access controller receiving the first frame signal from the south bridge chip

14. The wireless local area network access controller of claim 13 wherein the wireless local area network access controller is coupled to a physical layer chip, and the wireless local area network access controller is capable of controlling the physical layer in response to the access control signal.

15. The wireless local area network access controller of claim 14 wherein the second frame signal comprises an IEEE 802.11 header, an LCC control signal, an IEEE 802.x payload, and an IEEE 802.11 check sequence.

16. A method for generating a wireless local area network (WLAN) transmission signal comprising:
receiving a first frame signal;
retrieving a second frame signal complying with a wireless local area network transmission format and a access control signal according to the first frame signal; and
transmitting the second frame signal complying with the wireless local area network transmission format wirelessly.

17. The method of claim 16 further comprising:
executing a hardware control according to the access control signal.

18. The method of claim 16 wherein the first frame signal complies with an IEEE 802.3 communication protocol.

19. The method of claim 16 wherein the second frame signal complying with the wireless local area network transmission format is according to an IEEE 802.11 communication protocol.

20. The method of claim 19 wherein the second frame signal complying with the wireless local area network transmission format comprises an IEEE 802.11 header, an LCC control signal, an IEEE 802.x payload, and an IEEE 802.11 check sequence.

21. A method for receiving a wireless local area network transmission signal comprising:
receiving a first frame signal complying with a wireless local area network transmission format;
encapsulating the first frame signal into a second frame signal complying with a wired local area network transmission format; and
transmitting the first frame signal complying with the wired local area network transmission format to a south bridge chip.

22. The method of claim 21 wherein the first frame signal complying with the wired local area network transmission format is according to an IEEE 802.3 communication protocol.

23. The method of claim 21 wherein the second frame signal complying with the wireless local area network transmission format is according to an IEEE 802.11 communication protocol.
